(19) United States
(12) Patent Application Publication
(10) Pub. No.: US 2026/0222448 A1
(43) Pub. Date: Jul. 30, 2026

(54) SYSTEMS AND METHODS FOR ROUTING INTERNAL COMMUNICATIONS WHILE MAINTAINING A SECURED ENVIRONMENT AND SECURITY OVER INTERNAL DATA USING A BIFURCATED SECURITY PROTOCOL

(71) Applicant: Capital One Services, LLC, McLean, VA (US)

(72) Inventors: Hongyi HUANG, Haymarket, VA (US); Vijay Kumar GARIMELLA, Frisco, TX (US); Levani KHIDISHELI, Dobbs Ferry, NY (US)

(73) Assignee: Capital One Services, LLC, McLean, VA (US)

(21) Appl. No.: 19/037,039

(22) Filed: Jan. 24, 2025

(51) Int. Cl. H04L 9/40; G06N 3/0475; G06N 3/09

(52) U.S. Cl. CPC H04L 63/20; G06N 3/0475; G06N 3/09; H04L 63/0428

(57) ABSTRACT

Systems and methods for routing internal communications while maintaining a secured environment and security over internal data are described. For example, the system may process, by a first cloud-based collaboration and communication platform, a first secured input using a large language model, wherein the large language model is trained using a first training routine, of a bifurcated security protocol, for weighting the large language model to determine routing instructions or data retrieval locations for content retrieval operations, wherein the large language model is trained using a second training routine for weighting the large language model to determine intents or contexts of received inputs, and wherein the first training routine comprises filtering data from a first dataset based on whether the data has an indicium of user feedback.

### BACKGROUND

In recent years, many organizations have begun using cloud-based collaboration and communication platforms designed for teams to interact efficiently. Typically, these serve as a digital workspace where users can engage in real-time messaging, organize conversations into channels based on topics or projects, and/or share files and information seamlessly. These platforms may integrate with other tools and project management software, allowing teams to streamline workflows without switching between applications. Their features may include direct messaging, group chats, voice and video calls, and notifications that can be customized for individuals or teams. With their ability to enhance communication and improve productivity, these platforms are widely used in professional environments, from small businesses to large corporations, to facilitate better collaboration.

In parallel, many organizations are also using applications that are powered by artificial intelligence models, particularly large language models (LLMs), to enhance operations, decision-making, and customer experiences. AI models are sophisticated algorithms that can process and analyze data, identify patterns, and make predictions or decisions without explicit human instructions. Large language models, a subset of AI, are designed to understand and generate human language based on vast amounts of text data. These models, such as GPT (Generative Pre-trained Transformers), are capable of tasks like answering questions, generating content, translating languages, and even simulating conversations. Businesses use LLMs in various ways, such as automating customer service through chatbots, streamlining content creation, enabling advanced data analysis, and enhancing employee productivity by offering intelligent writing assistance or insights. These AI-powered applications allow organizations to scale operations, reduce costs, and improve overall efficiency by automating routine tasks and providing advanced capabilities that enhance decision-making processes.

### SUMMARY

Systems and methods are described herein for novel uses and/or improvements to cloud-based collaboration and communication platforms using artificial intelligence applications. As one example, systems and methods are described herein for cloud-based collaboration and communication platforms that have improved routing for internal communications while maintaining a secured environment and security over internal data.

For example, one problem with cloud-based collaboration and communication platforms is the sheer amount of data and access that they provide. Due to this, a new user to the platform may struggle to find, even with the help of search inputs and/or category designations, the particular content that is sought. In many cases, the new user must properly convey the intent, context, and/or any other criteria in a search input to the platform. One potential technical solution to this problem is through incorporation of LLMs. As stated above, LLMs may analyze data, identify patterns, and/or make predictions or decisions without explicit human instructions.

However, LLMs have one fundamental flaw: LLMs require a vast amount of high quality training data because they learn patterns, structures, and nuances of language from this data. The more diverse and comprehensive the dataset, the better the model becomes at understanding context, generating coherent responses, and handling a wide range of topics. High-quality data ensures the model can capture accurate representations of language, minimizing biases and errors while improving its performance across various tasks. However, training LLMs for cloud-based collaboration and communication platforms, such as those used by a single organization, typically requires training the model on data that is sensitive to that organization, such as personal, financial, and/or proprietary information, which poses significant challenges. This is problematic because the training process may inadvertently memorize or expose this sensitive data, raising concerns about privacy and security.

Conventional methods of protecting data, like encryption or anonymization, often fail during training because the models require access to raw data to learn from it. These methods may not fully prevent the model from storing and reproducing sensitive information during inference, leading to potential data leaks. Furthermore, LLMs are typically trained on large, centralized datasets, making it difficult to isolate sensitive information or guarantee that it won't be compromised. As a result, ensuring data privacy during LLM training requires specialized approaches, such as federated learning or differential privacy techniques, which aim to balance data protection with the need for extensive, high-quality training data.

In view of the conventional failures to protect the security of data needed to train a model as well as expand its ability to understand the nuances of individual cloud-based collaboration and communication platforms, the systems and methods use a bifurcated security protocol for training data submission and use. Using the bifurcated security protocol, the system may generate secured training data whereby the content and intent are determined (e.g., weighted in the LLM) using non-sensitive data and the routing and/or data source from which a response is pulled is determined (e.g., weighted in the LLM) using non-sensitive data. By bifurcating the security protocol used to generate the secured training data in this manner, the system gains the benefit of using a large amount of non-sensitive training data to determine intent and/or context, while limiting the exposure of sensitive training data.

However, limiting the training of the LLM to determine the routing and/or data source from which a response is pulled to just the sensitive data creates a novel technical problem. That is, the amount of data is likely insufficient for this purpose. While no conventional solutions are available for such a novel technical problem, one potential solution would be to generate synthetic training data to supplement the available data. However, this solution would not work as the routing and/or data source decisions need to be limited to the actual available routes and/or data retrieval locations (i.e., synthetically created place holders would degrade the precision and/or accuracy of the model). Instead, the system proposes a different technical solution, namely, maintain that current amount of data, but filter that data based on user feedback to increase its quality.

Notably, filtering an already limited data supply appears to be counterintuitive as it would further restrict the training data. Similarly, introducing a reliance on user feedback creates an additional burden on data-gathering that would typically further frustrate the training process. However, because of the particular environment involved (e.g., cloud-based collaboration and communication platforms), the sensitive data that is available already likely has a high incident of user feedback. Thus, this counterintuitive approach, in the particular environment of the present disclosure, provides a novel technical solution to the novel technical problem without creating an additional technical hurdle.

In some aspects, systems and methods for routing internal communications while maintaining a secured environment and security over internal data are described. For example, the system may receive, at a first cloud-based collaboration and communication platform, a first secured input, wherein the first secured input comprises an encryption native to the first cloud-based collaboration and communication platform. The system may process, by the first cloud-based collaboration and communication platform, the first secured input using a large language model, wherein the large language model is trained using a first training routine, of a bifurcated security protocol, for weighting the large language model to determine routing instructions or data retrieval locations for content retrieval operations, wherein the large language model is trained using a second training routine for weighting the large language model to determine intents or contexts of received inputs, and wherein the first training routine comprises filtering data from a first dataset based on whether the data has an indicium of user feedback. The system may determine, by the first cloud-based collaboration and communication platform, first content for appending to a first secured response to the first secured input based on a first intent or context determined by the large language model and a first routing instruction or data retrieval location by the large language model. The system may generate, by the first cloud-based collaboration and communication platform, the first secured response with the first content, wherein the first secured response and the first content comprise the encryption native to the first cloud-based collaboration and communication platform.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative user interface for an illustrative cloud-based collaboration and communication platform, in accordance with one or more embodiments.

FIG. 1B shows an illustrative user interface for pseudocode for an illustrative cloud-based collaboration and communication platform, in accordance with one or more embodiments.

FIG. 2A shows an illustrative diagram for an architecture for an illustrative cloud-based collaboration and communication platform, in accordance with one or more embodiments.

FIG. 2B shows an illustrative diagram for a data structure for user feedback indica, in accordance with one or more embodiments.

FIG. 3 shows illustrative components for a system used to facilitate bifurcated security protocols, in accordance with one or more embodiments.

FIG. 4 shows a flowchart of the steps involved in routing internal communications, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

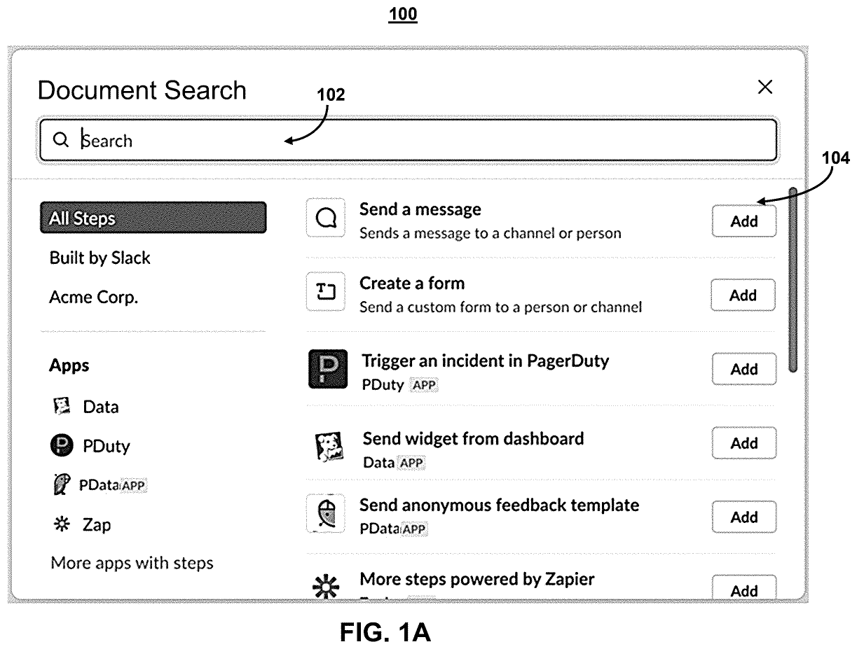

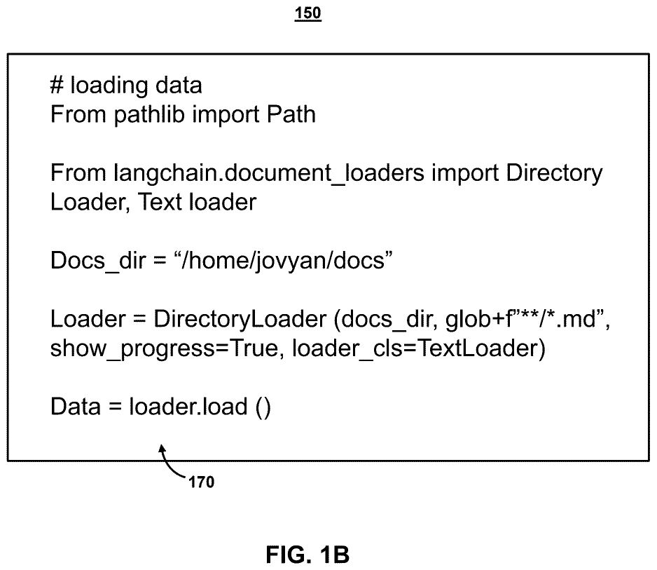

FIG. 1A shows an illustrative user interface for an illustrative cloud-based collaboration and communication platform, in accordance with one or more embodiments. For example, FIG. 1A shows user interface 100, which may comprise a user interface for a cloud-based collaboration and communication platform. As described herein, a cloud-based collaboration and communication platform may be a digital service hosted on remote servers that allows individuals or teams to interact, share information, and/or work together in real time, regardless of their location. These platforms may enable a user to communicate through messaging, voice, and video calls, and to collaborate by sharing files, managing projects, and coordinating tasks within a virtual workspace. In some embodiments, cloud-based collaboration platforms encompass a wide range of functionalities. They are often integrated with other productivity tools such as document editing software, project management systems, and cloud storage services, allowing seamless workflows across different applications. Some platforms also provide features for task tracking, workflow automation, and data sharing across multiple teams or departments, making them essential for remote work and global collaboration.

As referred to herein, a “user interface” may comprise a human-computer interaction and communication in a device, and may include display screens, keyboards, a mouse, and the appearance of a desktop. For example, a user interface may comprise a way a user interacts with an application or a website. User interface 100 may include search bar 102 (or other input mechanisms) for receiving inputs as well as displaying content (e.g., content 104).

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user-generated content may include content created and/or consumed by a user. For example, user-generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring the user. FIG. 1B shows an illustrative user interface for pseudocode for an illustrative cloud-based collaboration and communication platform, in accordance with one or more embodiments.

For example, user interface 100, may facilitate content (e.g., content 104) retrieval by providing an interactive platform through which users can input queries or commands to access information stored in a system. User interface 100 may receive inputs like search queries, navigation commands, or selections from menus, which can be in the form of typed text, voice commands, clicks, or touch gestures. These inputs are essentially instructions that tell the system what content or action the user is looking for. A search query, for example, is a specific input where the user provides keywords or phrases to retrieve relevant content from databases or online resources.

The user interface then processes these inputs and provides outputs, which can include search results, relevant documents, data visualizations, or other forms of content that match the user's request. Outputs are the responses generated by the system, typically displayed visually (e.g., lists of documents, images, or summaries) or as audio feedback, depending on the device and interface. The output provides the user with the information or content they were seeking, thus completing the interaction cycle between the user and the system. By streamlining the input-output flow, user interface 100 may ensure an efficient, intuitive way for users to retrieve content and interact with the system.

FIG. 1B shows an illustrative user interface for pseudocode for an illustrative cloud-based collaboration and communication platform, in accordance with one or more embodiments. For example, user interface 150 includes pseudocode 170. Pseudocode 170 may be used by a cloud-based collaboration platform that uses a bifurcated security protocol for training data submission and use. For example, using the bifurcated security protocol in pseudocode 170, the system may generate secured training data whereby the content and intent are determined (e.g., weighted in the LLM) using non-sensitive data and the routing and/or data source from which a response is pulled is determined (e.g., weighted in the LLM) using non-sensitive data.

For example, pseudocode 170 may comprise several operations and functions to ensure the secure handling of sensitive and non-sensitive data. In some instances, the bifurcated security protocol may be structured to separate the processing of content and intent from the routing and source of data, using non-sensitive data for model training to maintain privacy. For example, one set of operations may focus on securing and processing non-sensitive data for training the LLM. For example, pseudocode 170 might include functions that parse user input, extract non-sensitive intent, and then feed this data into the LLM to determine the general response or action without directly exposing sensitive content. This could be represented in a function that processes only the safe parts of the data, ensuring that the LLM weights the intent of communication based on this non-sensitive information.

Another function may be responsible for securing sensitive data during routing and determining the data source for responses. This might involve operations like identifying data sources and applying routing protocols that ensure sensitive data remains protected during interaction. A function may also handle non-sensitive metadata about the origin of the data, ensuring that any sensitive identifiers are protected while still allowing the system to accurately pull information from the correct source. In this way, the bifurcated security protocol ensures that the model can still learn and respond efficiently while safeguarding sensitive information. Operations in the pseudocode would separate content-related logic from routing and metadata, with secure handling of data in both paths, preventing sensitive information from being exposed during model training and usage.

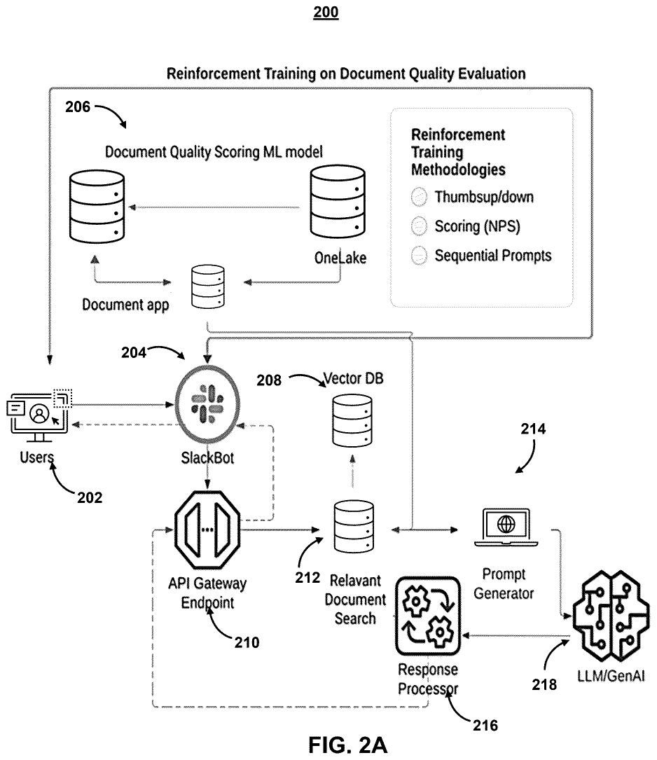

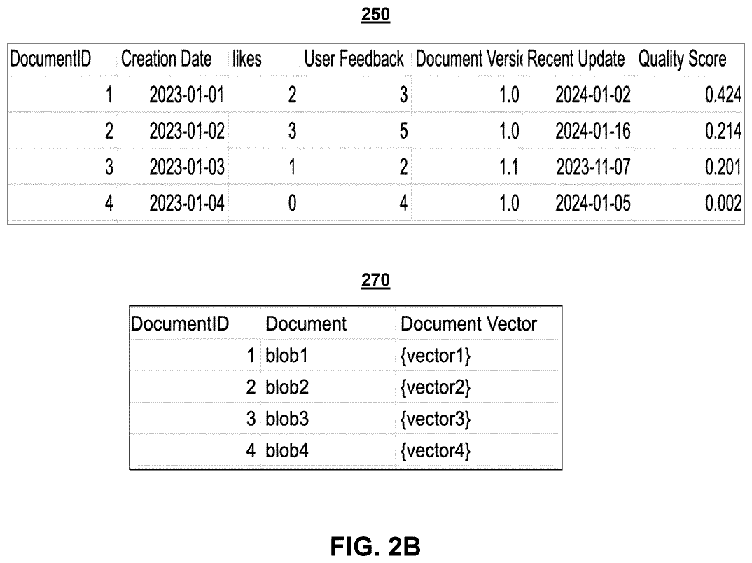

FIG. 2A shows an illustrative diagram for an architecture for an illustrative cloud-based collaboration and communication platform, in accordance with one or more embodiments. For example, FIG. 2A includes system 200. As shown in FIG. 2A, system 200 receives an input from users 202. The input may be received by cloud-based collaboration and communication platform 204. Cloud-based collaboration and communication platform 204 may also receive data from model 206. Model 206 may determine a document quality scoring machine learning model 206. Model 206 may use reinforcement training methodologies that use indicia of user feedback (e.g., thumbs up/down on a given comment, scoring for given content, results of sequential prompts, etc.). Cloud-based collaboration and communication platform 204 may then use data from model 206 and an input received from users 202 to find a relevant document using API Gateway 210, vector database 208, and relevant document search engine 212. System may also use prompt generator 214, response processor 216, and LLM 218 to generate a response.

For example, system 200 may facilitate user interactions by receiving inputs from users 202 and generating outputs through a sophisticated, multi-component process. When a user submits an input, such as a query or command, it is first received by the cloud-based collaboration and communication platform 204. This platform serves as the central hub, managing both user inputs and the data necessary to respond effectively. Alongside user input, the system receives data from model 206, which may be a machine learning model, such as a document quality scoring model. Model 206 may utilize reinforcement learning techniques to improve its performance based on user feedback, such as thumbs up or down on comments, ratings on content, or results from sequential user prompts. This feedback may be used by system 200 for refining the model's ability to assess document quality over time.

For example, the system may determine a quality score for given content, such as a document, by analyzing various forms of user feedback and comparing content characteristics. The platform assigns a quality score based on quantifiable metrics, such as the number of reposts, thumbs up, likes, or comments a document receives. These metrics reflect how users are engaging with the content, with higher engagement often indicating that the content is valuable, relevant, or well-received by the community. For example, a document that receives numerous thumbs up or likes is likely considered high quality by users, leading the system to assign it a higher quality score.

Additionally or alternatively, the system may determine a content quality score by comparing the characteristics of the document to other similar content. This might involve matching the text of one document with another to evaluate originality, relevance, or coherence. The system could also analyze the structure, writing style, or content accuracy to assess whether a document aligns with other high-quality content in the database. By using a combination of user feedback and content comparison, the platform creates a comprehensive evaluation system that ensures the quality score reflects both subjective user preferences and objective content characteristics.

This quality score can then be used to prioritize certain documents for recommendation, improve search results, or refine future content creation by learning what types of content tend to perform well. Over time, the platform's use of feedback data helps enhance content quality across the system by promoting content that consistently receives high engagement and positive responses.

Once cloud-based collaboration and communication platform 204 has both the user input and data from model 206, it interacts with additional system components to find the most relevant document. Specifically, the platform uses the API Gateway 210 to access the vector database 208, which stores document embeddings, and the relevant document search engine 212, which helps retrieve the best matching documents based on the input query.

After the relevant document is identified, the system may involve prompt generator 214 to formulate a specific query or response that aligns with the user's needs. The response processor 216 then refines the response, ensuring it is coherent and appropriately tailored. Large language model (LLM) 218 may be utilized to generate the final output, such as a recommendation, document, or answer, which is then delivered back to the user. This multi-step process, which integrates user feedback, machine learning, and document retrieval technologies, allows system 200 to provide intelligent, contextually relevant responses efficiently.

FIG. 2B shows an illustrative diagram for a data structure for user feedback indica, in accordance with one or more embodiments. For example, FIG. 2B shows data structure 250 and data structure 270. Data structure 250 may include various indicia of user feedback. For example, data structure 250 includes various fields of indicia related to designated content (e.g., documents 1-4). In some embodiments, indicia of user feedback may include both user feedback and/or characteristics related to user feedback (e.g., creation date, “likes,” a number of comments and/or other instances of user feedback, document versions receiving user feedback, updated dates for content, and/or a quality score for the content).

For example, data structure 250 may be used to record instances of user feedback and correlate it to particular content and is designed to efficiently store and track various forms of feedback and metadata associated with that feedback. For instance, data structure 250 may include multiple fields representing different indicia of user feedback related to specific content items, such as documents 1-4. This structure allows the system to organize and link user feedback to the corresponding content, enabling better analysis and response generation.

Each field within data structure 250 may capture specific characteristics of user feedback. For example, these fields could include the creation date of the feedback, the number of “likes” a particular document has received, and the number of comments or other forms of interaction, such as thumbs up/down ratings. Additionally, the structure could track document versions that receive feedback, helping to correlate feedback with specific updates or iterations of the content. It may also store timestamps for when the content was last updated and a quality score that evaluates the content's overall reception and effectiveness based on user interactions.

By maintaining these fields, data structure 250 enables the system to monitor trends in user feedback, analyze how content changes over time affect user reception, and use this information to refine content recommendations or improvements. This structured approach to storing feedback also aids in reinforcement learning, where the system learns to associate high-quality content with positive feedback, leading to better responses and decisions in the future.

Data structure 270 illustrates a data structure used by the system to record indicia of user feedback in a vector database. For example, the system may use a data structure to record indicia of user feedback in a vector database by converting various feedback metrics and content characteristics into numerical vectors that can be efficiently stored and queried. The data structure captures different aspects of user interactions, such as likes, reposts, comments, and ratings, as well as content metadata like creation date, document version, and update history. These feedback indicators are then transformed into a numerical format suitable for use in a vector database.

A vector is typically generated by mapping the data points—such as the number of likes, thumbs up, or the frequency of document reposts—into a multidimensional space, where each dimension represents a particular feature or characteristic of the content. For example, one dimension of the vector may represent the total number of likes, another might represent the average quality score assigned by users, and a third could account for engagement metrics like the number of comments or interactions. Additionally, content characteristics such as document length, content similarity to other documents, and the frequency of updates can also be encoded in the vector, ensuring that both user feedback and content attributes are captured.

Once the vector is generated, it is stored in the vector database, which is specifically designed to manage and retrieve high-dimensional vectors efficiently. These vectors are stored in a way that allows the system to quickly compute similarities between content items, rank documents by quality score, and retrieve relevant documents based on feedback patterns. The vector database enables fast searches and comparisons by calculating distances between vectors, allowing the system to find content with similar engagement or quality metrics.

The system may use data structure 270 to aggregate user feedback and content attributes into vectors, which are then stored in a vector database. This allows for efficient querying, comparison, and ranking of content based on both user feedback and content characteristics, improving content recommendations and quality assessments.

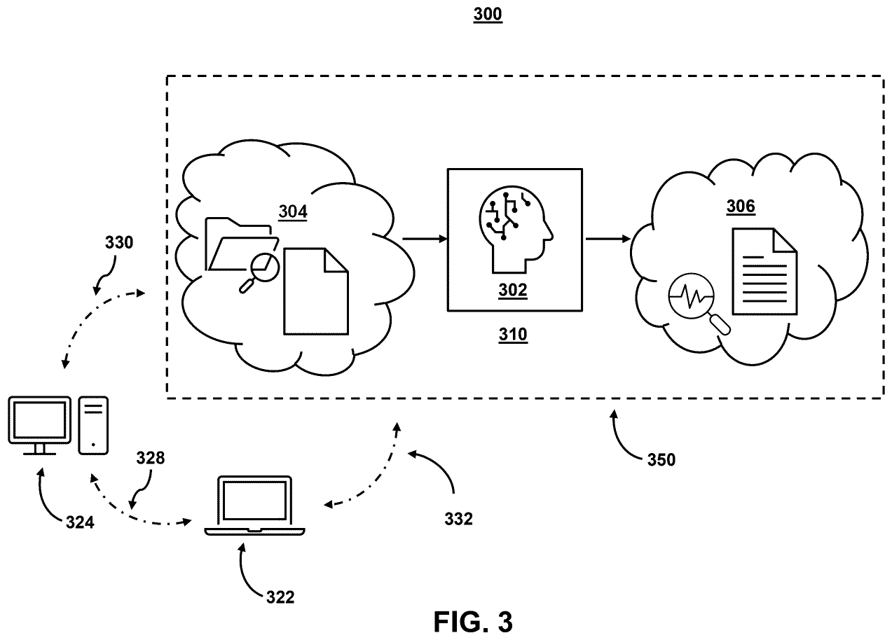

FIG. 3 shows illustrative components for a system used to facilitate bifurcated security protocols, in accordance with one or more embodiments. For example, FIG. 3 may show illustrative components for routing internal communications while maintaining a secured environment and security over internal data using bifurcated security protocols. As shown in FIG. 3, system 300 may include mobile device 322 and user terminal 324. While shown as a laptop computer and personal computer, respectively, in FIG. 3, it should be noted that mobile device 322 and user terminal 324 may be any computing device, including, but not limited to, a smartphone, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that, in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

In some embodiments, the system may use different datasets for different training purposes. For example, the system may receive a first dataset, wherein the first dataset comprises sensitive data, wherein the sensitive data is based on a first data source that is native to the first cloud-based collaboration and communication platform, and wherein the first dataset comprises the encryption native to the first cloud-based collaboration and communication platform.

For example, the system can receive and use both a first dataset and a second dataset by applying a bifurcated security protocol, which ensures that sensitive and non-sensitive data are handled appropriately during different stages of model training. The first dataset, which contains sensitive data, is derived from a data source native to the first cloud-based collaboration and communication platform. This dataset is encrypted using the platform's native encryption protocols, ensuring that sensitive information such as personal data, confidential communications, or proprietary content remains secure during the training process. The system retrieves this encrypted dataset and uses it for the first training routine, focusing on tasks where secure handling of sensitive information is critical. For example, this routine might train a model to understand and process secure communication flows, routing sensitive content, or managing encrypted data without exposing the underlying sensitive information.

In contrast, the second dataset comprises non-sensitive data and is sourced from various external platforms or systems that are not native to the first cloud-based collaboration and communication platform. This dataset does not carry the same encryption as the first dataset, as it deals with public, non-confidential, or less sensitive information. The system uses this second dataset for the second training routine, which focuses on tasks such as understanding general language patterns, recognizing intents, or learning from large, non-sensitive data sources. This allows the system to improve its language model's ability to generate responses, interpret queries, and provide contextually accurate outputs without dealing with sensitive data in this phase.

To manage these two distinct processes securely, the system retrieves a bifurcated security protocol, which delineates how the two datasets are used separately in their respective training routines. The bifurcated security protocol ensures that the first training routine only handles the encrypted sensitive dataset, maintaining strict security measures to prevent data breaches or unauthorized access. Simultaneously, the second training routine leverages the non-sensitive dataset, allowing for more flexibility in model training without the same level of encryption or security concerns.

By executing the bifurcated security protocol, the system can train the LLM effectively while keeping sensitive data protected and utilizing non-sensitive data for broader, context-based learning. This approach ensures that the model can provide accurate responses and insights without compromising the security of sensitive information, allowing the system to balance robust functionality with privacy and security considerations.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., determining relevant content, generating responses, generating content with a response, and/or determining quality scores for content).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., determining relevant content, generating responses, generating content with a response, and/or determining quality scores for content).

In some embodiments, the model (e.g., model 302) may automatically perform actions based on outputs 306. In some embodiments, the model (e.g., model 302) may not perform any actions. The output of the model (e.g., model 302) may be used to determine relevant content, generate responses, generate content with a response, and/or determine quality scores for content.

In some embodiments, the system may generate predictions related to financial services. For example, the system may use one or more models and/or applications to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the system may generate a quality score through a Model-as-a-Service (MaaS) platform. The platform may be leveraged to generate quality scores for documents and other content by integrating user feedback signals, such as likes, reposts, thumbs up, and other engagement metrics, into machine learning models. The platform may provide pre-trained or customizable models that analyze the feedback data to evaluate content quality. The process begins by collecting user interaction data, which is then pre-processed to identify patterns and assign weights to various types of feedback based on their importance. For instance, a repost might carry more weight than a like, reflecting its higher engagement value. The MaaS model analyzes this data in combination with content-specific features, such as readability, relevance, or adherence to topic, to compute a comprehensive quality score. Advanced implementations might also incorporate sentiment analysis or contextual understanding of feedback, ensuring the scores reflect nuanced user preferences. By using MaaS, organizations can continuously refine these models, ensuring they remain adaptive to changing user behaviors and preferences, ultimately driving better content curation and user experience.

The training process for a model used in a MaaS setup to generate quality scores involves several key steps. It begins with the collection of a large dataset, which includes content, user interactions (e.g., likes, shares, comments), and contextual metadata such as timestamps and user demographics. From this data, relevant features are extracted or engineered, such as content-based attributes (e.g., readability, tone, keywords, sentiment), interaction metrics (e.g., likes, shares, dwell time), user profile features, and temporal trends. The dataset may be labeled explicitly by expert reviewers or implicitly by treating highly engaged content as high-quality examples. A suitable machine learning model, such as regression models for continuous scores or classification models for categorization, is then selected based on the complexity of the task. The model is trained on the labeled data, learning to associate features with quality labels or scores, using optimization techniques like gradient descent to minimize errors. Its performance is evaluated on validation and test datasets using metrics like accuracy, F1-score, or mean squared error, and adjustments are made as needed through fine-tuning. Once the model demonstrates robust performance, it is deployed via the MaaS platform, often with mechanisms for continuous learning to incorporate fresh data and evolving user feedback. This comprehensive process ensures that the model remains accurate, adaptive, and aligned with changing trends in user interactions and preferences.

Training data for a MaaS model can be generated using user messages and metadata from existing documents by leveraging these resources to extract meaningful features and labels. User messages can provide rich contextual data, including message content, timestamps, user information, channels, and engagement metrics like reactions or replies. These can be processed to identify patterns in communication, sentiment, and relevance to specific topics. Similarly, document metadata such as author information, creation and modification timestamps, document hierarchy, usage statistics (e.g., views, downloads), and related tags or keywords can be integrated to enrich the dataset. Labels for training can be derived explicitly, for example, by manual annotation of high-quality documents or messages, or implicitly by tracking engagement metrics such as frequent referencing or positive feedback. Natural language processing (NLP) techniques can be applied to user messages to extract sentiment, topic, or key phrases, while metadata can provide context, such as document importance or usage trends. This combined dataset allows the MaaS model to learn how different features correlate with perceived quality or relevance, enabling it to generate accurate quality scores for future content and communication.

To generate quality scores, data related to messages is formatted and standardized through a structured preprocessing pipeline. First, raw message data, including text, timestamps, user details, and engagement metrics, is collected and cleaned to remove irrelevant information such as system messages or incomplete data. Text data is processed using natural language processing (NLP) techniques, which include tokenization, removal of stop words, lemmatization, and sentiment analysis to extract meaningful features like tone, sentiment, or topic relevance. Engagement metrics such as reactions, replies, or shares are normalized to ensure comparability across messages of varying lengths and contexts. Metadata, such as timestamps or user roles, is standardized into consistent formats, such as ISO date-time strings or categorical variables. Features are encoded in a machine-readable format; for example, text can be converted into vector representations using techniques like TF-IDF, word embeddings, or transformer-based models. All features are then scaled or normalized to ensure uniformity and avoid dominance by metrics with larger numerical ranges. By transforming and standardizing the data into a cohesive structure, it becomes suitable for feeding into machine learning models, enabling the generation of reliable and unbiased quality scores for messages and related content.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjust the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

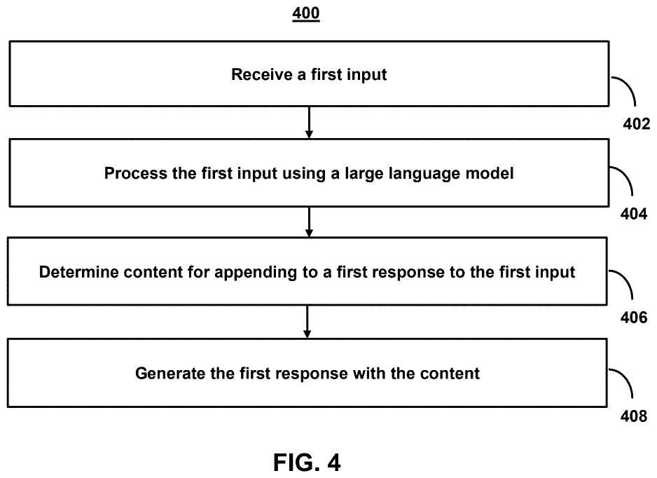

FIG. 4 shows a flowchart of the steps involved in routing internal communications, in accordance with one or more embodiments. For example, the system may use process 400 (e.g., as implemented on one or more system components described above) in order to route internal communications while maintaining a secured environment and security over internal data using bifurcated security protocols.

At step 402, process 400 (e.g., using one or more components described above) receives a first input. For example, the system may receive, at a first cloud-based collaboration and communication platform, a first secured input, wherein the first secured input comprises an encryption native to the first cloud-based collaboration and communication platform. In some embodiments, the system may receive a first secured input at a cloud-based collaboration and communication platform by leveraging encryption mechanisms that are native to that platform. When a user submits an input, such as a message, document, or request, the platform automatically encrypts this data using its proprietary encryption protocols. This encryption process ensures that the data remains secure as it travels across the cloud infrastructure. The first secured input, therefore, arrives at the platform already encrypted, with the encryption format specific to the platform's security architecture. For example, the cloud-based platform may use symmetric or asymmetric encryption methods, where the input is encrypted with a unique key tied to the platform or the user's session. Upon receipt, the platform authenticates the secured input, verifying that it originated from a trusted source and was encrypted according to its internal encryption standards. The system then decrypts the input, processes it as required, and applies the appropriate logic based on the user's request. This encryption native to the cloud-based collaboration and communication platform ensures that sensitive data is protected throughout the transmission and handling process, maintaining security, privacy, and compliance with data protection regulations. This enables users to confidently interact with the platform, knowing their inputs are securely transmitted and processed.

In some embodiments, the system may execute a bifurcated security protocol to perform the first training routine by determining respective indicia of user feedback for content in the first dataset and filtering the content in the first dataset based on the respective indicia of user feedback. For example, the system executes a bifurcated security protocol to perform the first training routine by applying strict security measures to handle sensitive data in the first dataset, while also filtering and refining that data based on user feedback. The first training routine focuses on ensuring that the large language model (LLM) is trained securely without compromising sensitive information. The system begins by accessing the first dataset, which contains sensitive content that is encrypted using the platform's native encryption protocols. This dataset may include proprietary documents, private communications, or other sensitive content relevant to the cloud-based platform.

To enhance the quality of the training process, the system evaluates the content in the first dataset by determining respective indicia of user feedback for each piece of content. Indicia of user feedback may include metrics such as how many users liked or disliked a particular document, the number of comments or edits made to it, user ratings, or the frequency with which the content was accessed or shared. These feedback metrics provide insight into the perceived value or relevance of the content within the platform. By analyzing this feedback, the system can prioritize high-quality or well-regarded content for training purposes, ensuring that the LLM is exposed to the most relevant and reliable data. Next, the system filters the content in the first dataset based on the respective indicia of user feedback. Content with positive feedback or high engagement may be prioritized in the training process, while content with low feedback or poor ratings could be excluded or given less weight. This filtering process ensures that only the most useful and validated sensitive data is used to train the model, enhancing the LLM's ability to perform tasks related to secure content handling, such as routing sensitive data or generating responses within secure environments. By executing this part of the bifurcated security protocol, the system ensures that the first training routine is both secure and optimized. The protocol guarantees that sensitive data is protected throughout the training process while incorporating user feedback to refine the dataset, improving the model's performance in handling secure, high-quality content without exposing sensitive information.

At step 404, process 400 (e.g., using one or more components described above) processes the first input using a large language model. For example, the system may process, by the first cloud-based collaboration and communication platform, the first secured input using a large language model, wherein the large language model is trained using a first training routine, of a bifurcated security protocol, for weighting the large language model to determine routing instructions or data retrieval locations for content retrieval operations, and wherein the large language model is trained using a second training routine for weighting the large language model to determine intents or contexts of received inputs.

In some embodiments, the system may process a first secured input at the cloud-based collaboration and communication platform by using a LLM that has been trained according to a bifurcated security protocol. This protocol separates the training of the model into two distinct routines, ensuring that the system can securely and efficiently handle both content retrieval and understanding of user inputs. In the first phase, the LLM is trained using a first training routine that focuses on determining routing instructions and identifying data retrieval locations. This routine ensures that the model learns to understand where relevant information is stored and how to access it based on non-sensitive metadata, such as document tags, content types, or storage locations. By assigning weights in the LLM based on these factors, the system can process the secured input to direct the content retrieval operations without exposing sensitive data. For example, the LLM may use non-sensitive elements from the input to identify which database or data source to query, thereby streamlining the retrieval process while maintaining data security.

The second training routine focuses on determining the intent or context of the received inputs. In this phase, the LLM is trained to interpret the meaning behind the user's input, such as understanding whether the user is asking a question, making a request, or seeking specific information. This aspect of training involves analyzing non-sensitive aspects of language, such as patterns of phrasing, keywords, and contextual clues, to accurately identify the user's intent without requiring access to sensitive content. By weighting the model to prioritize intent recognition, the system ensures that the LLM can interpret user inputs and respond appropriately, whether it is to answer a query, retrieve a document, or provide guidance. Together, these two training routines enable the LLM to handle secured inputs effectively. The bifurcated security protocol ensures that sensitive data is protected, as the model's training on routing and data retrieval operates separately from its training on understanding the content's intent or context. This approach allows the system to maintain high levels of security while delivering accurate and contextually relevant responses.

In some embodiments, the system may train the large language model using the second training routine by retrieving a first historic input corresponding to a first labeled intent or context and training the large language model to classify the first historic input as the first labeled intent or context. For example, the system trains the LLM using the second training routine by focusing on non-sensitive data to improve the model's ability to understand and classify user inputs based on intent or context. In this process, the system retrieves a first historic input, which is an example of previous user interactions that has already been analyzed and labeled with a specific intent or context. This labeled intent might include categories such as a question, request for information, suggestion, or command, and it serves as a training example to guide the model's understanding of similar future inputs.

Once the system retrieves this first historic input and its corresponding labeled intent or context, it uses this data to train the LLM to recognize and classify similar inputs accurately. The system processes the historic input through the model, analyzing the language patterns, phrasing, keywords, and other contextual clues present in the text. By associating these features with the labeled intent, the system adjusts the weights within the LLM, effectively teaching the model to recognize when future inputs share similar characteristics. For instance, if the historic input is a question asking for help (“How do I reset my password?”), the model learns to classify similar future queries under the same intent category, such as “technical support.” Through repeated exposure to various historic inputs labeled with different intents and contexts, the LLM becomes more adept at classifying inputs. This process involves feeding the model large quantities of labeled data from multiple contexts, allowing it to develop a nuanced understanding of language that aligns with user expectations. By continuously adjusting its internal weights during training, the model improves its accuracy in identifying the intent behind user inputs, enabling it to generate more appropriate and contextually relevant responses during real-world interactions. The second training routine, which focuses on non-sensitive data, is crucial for enhancing the model's natural language understanding capabilities. It enables the system to train the LLM without exposing sensitive information, while still refining the model's ability to classify and respond to a wide range of user inputs based on their underlying intent or context.

In some embodiments, the system may retrieve a bifurcated security protocol by accessing a structured set of procedures that separates the training of a large language model (LLM) into two distinct phases. The bifurcated security protocol is designed to ensure that sensitive data is handled securely and efficiently during content retrieval operations. The first component of the protocol involves a training routine that specifically focuses on routing instructions and determining data retrieval locations. This routine trains the LLM to recognize patterns in non-sensitive metadata associated with the input, such as document types, data sources, or storage locations. By assigning appropriate weights during this training, the LLM learns how to guide content retrieval operations without relying on sensitive data. The model becomes adept at understanding how to locate relevant information based on inputs that are secured and safe, ensuring that the system can retrieve content without compromising user privacy. The second component of the bifurcated protocol involves a separate training routine that focuses on understanding the intent or context of the received inputs. This routine trains the LLM to interpret the meaning or purpose behind user queries or commands. By weighting the model to prioritize patterns in language structure, keyword usage, and contextual cues, the LLM becomes capable of accurately determining whether the user is requesting information, making a suggestion, or initiating some other action. Importantly, this training routine also operates on non-sensitive data, allowing the model to discern intent without exposing or utilizing sensitive content. By separating these two training routines, the bifurcated security protocol allows the system to train the LLM in a secure and efficient manner. The first routine focuses on the logistical aspects of data retrieval, while the second focuses on understanding user input. This separation of concerns ensures that the model can deliver accurate, contextually appropriate responses while maintaining the security and integrity of sensitive information throughout the process. The system retrieves this bifurcated protocol as part of its overall strategy for secure and intelligent data handling, leveraging it to process inputs and deliver content in a way that balances both functionality and security.

In some embodiments, the system may train the large language model using the first training routine by retrieving a first historic input corresponding to a first labeled content retrieval operation and training the large language model to classify the first historic input as corresponding to the first labeled content retrieval operation. For example, the system trains the large language model (LLM) using the first training routine by focusing on teaching the model how to handle secure content retrieval operations. This process involves retrieving a first historic input that corresponds to a specific labeled content retrieval operation. The historic input is an example of a past user query or command that required the system to locate and retrieve specific content, such as a document, dataset, or other resources. This input has been previously labeled, meaning it is associated with a particular type of content retrieval operation, such as searching a database, accessing a file, or navigating a specific data source. To train the LLM, the system processes this first historic input and its associated content retrieval label. The labeled retrieval operation indicates the type of action the model should take when encountering similar inputs in the future. For example, if the historic input is “Find the latest sales report,” the labeled content retrieval operation would direct the model to retrieve a document from the system's sales database. The system uses this labeled example to train the LLM to recognize when future inputs should trigger similar content retrieval actions.

During training, the model analyzes the language patterns and structure of the historic input to learn how certain types of queries or commands correspond to specific retrieval operations. By adjusting the weights within the LLM, the system teaches the model to classify inputs that resemble the first historic input as corresponding to the same type of content retrieval operation. This allows the LLM to efficiently identify the appropriate data sources, databases, or files to access when processing similar user requests in the future. The system continuously exposes the model to various historic inputs and their corresponding retrieval operations, allowing it to build a robust understanding of how different inputs map to different content retrieval tasks. As the model becomes more proficient at classifying inputs, it becomes better at routing requests to the correct data sources or executing the correct retrieval operation. This training process is crucial for ensuring that the LLM can handle secure content retrieval efficiently, particularly in environments where sensitive data is involved, as it enables the model to determine how to access the right content without exposing sensitive information. By executing this first training routine, the system ensures that the LLM is equipped to classify inputs based on their content retrieval requirements, optimizing the model's ability to handle requests in a secure and contextually appropriate manner.

In some embodiments, the system may train the large language model using the first training routine by retrieving a first historic content corresponding to a first labeled content retrieval operation and training the large language model to classify the first historic content as corresponding to the first labeled content retrieval operation. For example, system trains the LLM using the first training routine by retrieving a first historic content that corresponds to a specific labeled content retrieval operation. This historic content is an example of a document, file, or dataset that was previously retrieved as part of a content retrieval process. The content is labeled according to the retrieval operation that was used to access it, such as querying a database, fetching a report, or navigating a specific content repository. To train the LLM, the system processes this historic content and the associated label indicating the content retrieval operation. The labeled retrieval operation helps the model understand the relationship between the type of content and the method used to retrieve it. For instance, if the historic content is a sales report that was fetched using a specific database query, the label might indicate that this content retrieval operation involved accessing the system's sales database. The model uses this information to learn how to associate similar types of content with corresponding retrieval operations.

During the training process, the system exposes the LLM to a variety of historic content examples and their labeled retrieval operations. The LLM is trained to recognize patterns and attributes within the content, such as its format, keywords, or metadata, that signal which retrieval operation should be applied when handling similar future content requests. For example, if the historic content is financial data, the LLM learns to classify it as requiring a specific financial database retrieval method. By adjusting its internal parameters, the model learns to map the characteristics of the content to the correct retrieval operation, ensuring that it can handle similar content retrieval tasks in the future. This training routine helps the model develop the ability to automatically classify different types of content based on their retrieval needs. By learning from historic content and its associated retrieval methods, the LLM becomes more effective at determining the appropriate content retrieval operation for new inputs. This is particularly important in secure environments where content may reside in different data sources or require specific access protocols. Through this first training routine, the system ensures that the LLM is capable of classifying and retrieving content accurately, making it more efficient at content retrieval operations while preserving the security and integrity of the system. The model becomes adept at identifying which content retrieval operation to apply based on the nature of the content being requested, streamlining the process of accessing relevant information in real-time applications.

In some embodiments, the system processing the first input using the large language model by determining a feature input corresponding to the first secured input and inputting the feature input into the large language model. For example, the system may process the first input using a LLM by converting the secured input into a format that the model can interpret and analyze. The process begins with the system receiving the first secured input, which could be a user query, command, or any other type of request. Since the input is secured, it may be encrypted or formatted in a way that protects sensitive data. To enable the LLM to process this input, the system must first extract relevant information from it without compromising security. The system begins by determining a feature input corresponding to the first secured input. This involves identifying key features or elements of the input that are necessary for the LLM to understand and process the request. For example, if the secured input is a question, the system might extract features such as keywords, topic categories, or intent. These features are distilled into a “feature input,” which is a simplified, abstracted version of the original input that retains the essential information needed for the LLM to process it. Once the feature input is determined, it is then inputted into the large language model. The feature input serves as the model's starting point, allowing the LLM to analyze the content, understand its context, and generate a relevant output or response. The LLM processes the feature input by leveraging its pre-trained knowledge of language patterns, semantics, and context to interpret the user's intent and provide an appropriate response. For example, if the feature input represents a user's query about retrieving a document, the LLM would analyze the query's structure and context to determine how best to fulfill the request. By determining and inputting the feature input into the large language model, the system ensures that even secured inputs can be processed efficiently and accurately. This approach enables the system to handle sensitive or encrypted data while still utilizing the powerful capabilities of the LLM to generate meaningful responses or perform required operations.

At step 406, process 400 (e.g., using one or more components described above) determines content for appending to a first response to the first input. For example, the system may determine, by the first cloud-based collaboration and communication platform, first content for appending to a first secured response to the first secured input based on (i) a first intent or context determined by the large language model and a first routing instruction or data retrieval location determined by the large language model; and (ii) filtering available content from a first dataset based on whether the available content has a first indicium of user feedback.

In some embodiments, the system determines the first content further comprises determining a number of the first indicium of user feedback that corresponds to the first content, retrieving a threshold number, and determining that the number of the first indicium of user feedback corresponds to the threshold number. For example, the system may determine the first content by evaluating user feedback associated with that content and comparing it to a predefined threshold. The process begins by identifying and counting the first indicium of user feedback related to the content. The first indicium could be a specific type of feedback, such as the number of likes, upvotes, comments, or any other engagement metric that reflects how users have interacted with the content. For example, if the content is a document or a file, the system would calculate how many times it has been liked or commented on by users. Next, the system retrieves a threshold number that serves as a benchmark for evaluating the quality or relevance of the content. This threshold is typically pre-defined within the system and can be based on various criteria such as platform standards, user engagement goals, or historical data patterns. For instance, the threshold could be set at 100 likes or 50 comments, depending on what level of feedback is considered significant in the context of the platform. After retrieving the threshold number, the system compares the number of the first indicium of user feedback (e.g., the total likes or comments) to the threshold number. If the feedback count meets or exceeds the threshold, the system determines that the content is sufficiently validated or popular, indicating that it may be prioritized for further actions such as content retrieval, recommendations, or inclusion in training datasets. On the other hand, if the feedback falls short of the threshold, the content may not be deemed as highly valuable or relevant, and the system may deprioritize it for certain operations. By using this method, the system ensures that only content with a sufficient level of user engagement or approval is considered for further processing or inclusion, which helps to maintain the quality of content used in various workflows.

In some embodiments, the system determines the routing instructions or the data retrieval locations for the content retrieval operations by determining a content type corresponding to a content retrieval operation and determining a network pathway to a data source corresponding to the content type. For example, the system determines routing instructions or data retrieval locations for content retrieval operations by identifying the type of content being requested and then selecting the appropriate network pathway to access the corresponding data source. The process begins when the system receives a content retrieval request, such as a query for a specific document, file, or dataset. The system first analyzes the request to determine the content type. This content type could be based on file format (e.g., text, PDF, image), the category of data (e.g., financial reports, user-generated content), or the nature of the request (e.g., real-time data, archived records). Once the content type is identified, the system uses this information to determine the most suitable network pathway to access the data source that contains the requested content. Different content types are often stored in distinct data repositories or databases, each optimized for a specific kind of data. For example, financial data might reside in a secure financial database, while images or multimedia files could be stored in a content delivery network (CDN) or a cloud-based storage service. The system then maps the content type to the appropriate data source and selects the optimal network pathway. This pathway might include specific server locations, APIs, or cloud services that the system must connect to in order to retrieve the content. The routing instructions are generated based on this pathway, guiding the system through the necessary network protocols and connection points to retrieve the data efficiently and securely. For instance, if the content type is highly sensitive, the system may route the request through a secure VPN or encrypted channel to ensure data privacy. By determining the content type and identifying the correct network pathway to the corresponding data source, the system ensures that the content retrieval operation is both accurate and optimized for speed and security. This approach allows the system to handle diverse types of content and data sources while ensuring the correct routing and retrieval processes are followed for each type of request.

In some embodiments, the system generates a secured response by leveraging the encryption mechanisms that are native to the first cloud-based collaboration and communication platform. When the platform prepares a response—such as retrieving a document or generating a piece of content in response to a user query—it ensures that both the content and the response are encrypted before they are transmitted back to the user. The process begins when the platform identifies or creates the content that forms the basis of the response, such as retrieving information from a database, processing it through a large language model (LLM), or assembling a relevant document. Once the first content is ready, the platform applies its proprietary encryption protocol. This encryption ensures that the content remains secure while it is stored within the system and during transmission to the user. The encryption typically uses algorithms such as AES (Advanced Encryption Standard) or other cryptographic techniques that are integrated into the platform's security infrastructure. After encrypting the content, the system generates the first secured response, which combines the encrypted content with additional metadata or instructions needed for secure delivery. This response, along with the first content, is encrypted using the same native encryption protocol of the platform, ensuring end-to-end security. The secured response is then transmitted over the cloud-based infrastructure, protecting the integrity and confidentiality of the data throughout the entire process. When the response reaches the recipient, the platform's decryption mechanisms allow the intended user to access the content securely. Because both the response and the content were encrypted by the platform's native encryption methods, only authorized users with the proper decryption keys or permissions can view the information, ensuring that the data is protected against unauthorized access. This approach maintains the security of sensitive information while allowing the system to generate and deliver relevant responses efficiently.

In some embodiments, the system determines the first content by determining that the first indicium of user feedback corresponds to the first content, determining a quality ranking corresponding to the first indicium of user feedback, retrieving a threshold quality ranking, and determining that the quality ranking corresponding to the first indicium of user feedback corresponds to the threshold quality ranking. For example, the system may determine the first content by evaluating the quality and relevance of user feedback through a multi-step process that involves assessing the feedback, ranking it, and comparing it to a predefined quality threshold. The process begins with the system identifying the first indicium of user feedback that corresponds to the content in question. This feedback could be metrics such as the number of likes, comments, shares, or upvotes that a particular piece of content—such as a document or a file—has received from users. The system ensures that this feedback is directly tied to the content being evaluated. Once the first indicium of user feedback is identified, the system assigns a quality ranking to it. This quality ranking is typically based on predefined criteria or an algorithm that weighs different types of feedback. For example, likes may contribute less to the quality ranking than comments or detailed reviews, as comments can provide more insight into the usefulness or relevance of the content. The system calculates an overall quality ranking for the content based on how significant the feedback is deemed to be. Next, the system retrieves a threshold quality ranking, which serves as a benchmark for determining whether the content is of high enough quality to be prioritized. This threshold is predefined within the system and reflects the minimum level of quality that content must meet to be considered valuable or relevant. For example, the threshold quality ranking could be set at a specific score, such as 80 out of 100, which represents a high level of user satisfaction or engagement. Finally, the system compares the quality ranking of the first indicium of user feedback to the threshold quality ranking. If the content's quality ranking meets or exceeds the threshold, the system determines that the content is of sufficient quality for further actions, such as content retrieval, inclusion in recommendations, or use in training datasets. If the quality ranking falls below the threshold, the system may deprioritize the content or exclude it from certain processes. By determining content quality in this way, the system ensures that only highly rated or well-received content is considered for further use, improving the overall efficiency and effectiveness of content management, retrieval, and model training processes.

In some embodiments, the system determines the first content by determining that the first indicium of user feedback corresponds to the first content, determining a first user feedback type corresponding to the first indicium of user feedback, retrieving a required user feedback type, and determining that the first user feedback type corresponds to the required user feedback type. For example, the system determines the first content by analyzing the type of user feedback associated with it and ensuring that this feedback aligns with a required feedback type. The process begins by identifying the first indicium of user feedback that corresponds to the specific content, such as a document, post, or file. The indicium could include various forms of engagement, such as likes, comments, shares, or upvotes, reflecting how users have interacted with the content. After identifying this feedback, the system then determines the specific user feedback type that corresponds to the first indicium. For example, the system may classify the feedback as “likes,” “comments,” “reviews,” or other engagement metrics. Each type of feedback can be categorized based on how it contributes to the evaluation of the content. For instance, comments might indicate a deeper level of user interaction compared to a simple like, and therefore could be treated differently during the analysis. Next, the system retrieves a required user feedback type from its pre-defined criteria, which represents the type of feedback that is considered most relevant or necessary for the given evaluation. The required user feedback type may vary depending on the context, such as when comments or reviews are prioritized over simple reactions for evaluating content quality or relevance. For example, if the system requires detailed feedback such as comments or ratings to make an informed decision about the content's value, it will prioritize these types of feedback over less detailed forms like likes or views. Finally, the system compares the first user feedback type with the required user feedback type. If the first user feedback type matches the required type (e.g., comments, if detailed user engagement is required), the system concludes that the feedback is appropriate for evaluating the content. If they match, the content is flagged as relevant or high-quality, enabling it to be used in further processes like content retrieval, prioritization, or recommendation. If the first feedback type does not correspond to the required type, the system may disregard or deprioritize the content for certain actions. This process ensures that only content with the appropriate type of user feedback is considered, allowing the system to filter out content that may not have the necessary depth of engagement or interaction needed for specific use cases, such as inclusion in training datasets or recommendations.

In some embodiments, the system determines the first content by determining that the first indicium of user feedback corresponds to the first content, determining an update frequency corresponding to the first indicium of user feedback, retrieving a threshold update frequency, and determining that the update frequency corresponding to the first indicium of user feedback corresponds to the threshold update frequency. For example, the system determines the first content by evaluating the update frequency of user feedback associated with it and comparing it to a predefined threshold. The process begins by identifying the first indicium of user feedback related to the content, such as a document, post, or file. This feedback could include various forms of interaction, such as comments, likes, or edits, which provide insight into how users are engaging with the content over time. Once the first indicium of user feedback is identified, the system then determines the update frequency corresponding to this feedback. Update frequency refers to how often the content has received new user feedback or interaction over a specific period of time. For instance, if the content is frequently updated with new comments or receives consistent likes, the system recognizes that the content is actively engaging users. The system calculates how frequently these updates occur, such as daily, weekly, or monthly, depending on the feedback activity. Next, the system retrieves a threshold update frequency, which serves as a benchmark for evaluating the relevance or freshness of the content. This threshold could be predefined based on the platform's standards or business requirements, indicating the minimum level of engagement necessary to consider the content as frequently updated. For example, the threshold might be set to weekly updates, meaning that content must receive new user feedback at least once a week to be considered relevant or timely. Finally, the system compares the update frequency corresponding to the first indicium of user feedback to the threshold update frequency. If the update frequency meets or exceeds the threshold (e.g., the content receives new feedback on a weekly basis), the system determines that the content is actively engaged and likely remains relevant. As a result, this content may be prioritized for further actions such as content retrieval, inclusion in recommendations, or other content-related operations. If the update frequency falls below the threshold, the content may be considered less relevant or outdated, and the system may deprioritize it for future use.

In some embodiments, the system determines the first content by determining that the first indicium of user feedback corresponds to the first content, determining a receipt date corresponding to the first indicium of user feedback, retrieving a threshold receipt date for user feedback, and determining that the receipt date corresponds to the threshold receipt date. For example, the system determines the first content by analyzing the timing of user feedback and comparing it to a threshold to evaluate the relevance or freshness of the content. The process starts by identifying the first indicium of user feedback that corresponds to the content, such as a document, post, or file. This feedback might include interactions like comments, likes, or reviews that reflect how users have engaged with the content over time. After identifying the relevant user feedback, the system determines the receipt date of the feedback, which is the specific date when the feedback was submitted. For example, the receipt date could represent when a comment was posted, when a like was given, or when a review was submitted. This date provides insight into how recent or current the user engagement is, which is important for assessing whether the content is still relevant. Next, the system retrieves a threshold receipt date for user feedback. This threshold serves as a benchmark to evaluate whether the feedback is recent enough to consider the content as actively engaged or up-to-date. The threshold receipt date could be predefined by the platform, setting a specific timeframe, such as within the last month, week, or any other period that the system uses to judge the recency of feedback. For example, if the threshold receipt date is set to one month, only content with feedback received within the past 30 days would be considered relevant. The system then compares the receipt date of the first indicium of user feedback to the threshold receipt date. If the receipt date of the feedback meets or exceeds the threshold (i.e., the feedback was received within the specified time frame), the system determines that the content is still actively engaged by users and likely remains relevant. As a result, this content may be prioritized for further actions, such as content retrieval, recommendations, or additional processing. However, if the receipt date falls outside of the threshold (e.g., feedback was received too long ago), the system may deprioritize the content, considering it less relevant or outdated. By determining the receipt date of user feedback and comparing it to a threshold, the system ensures that only content with recent, active engagement is prioritized for further use, improving the relevance and timeliness of content management and retrieval operations.

In some embodiments, the system determines the first content by determining a document vector corresponding to the first content and determining that the first indicium of user feedback corresponds to the first content based on the document vector. For example, the system determines the first content by leveraging a document vector, which is a numerical representation of the content used for efficient comparison and retrieval in vector-based systems. The process begins by generating or retrieving a document vector corresponding to the first content. This document vector is created through a process known as embedding, where the system converts the content—such as a document, article, or post—into a mathematical representation. The vector encodes key features of the content, including its semantics, structure, and context, into a multi-dimensional space, allowing the system to compare it with other vectors. Once the system has the document vector for the first content, it determines whether the first indicium of user feedback corresponds to that content by analyzing the feedback in relation to the document vector. The system matches the feedback (such as likes, comments, or interactions) to the content by assessing whether the feedback can be linked to the same document vector. For instance, if the feedback was given on a specific document, the system associates that feedback with the document vector representing that content. By using the document vector, the system can accurately correlate the feedback to the content, even in cases where traditional methods, such as simple text matching, may fall short due to content variations or complex structures. The document vector provides a more robust method for associating feedback with content, ensuring that the system correctly identifies the first indicium of user feedback as belonging to the correct content. Through this approach, the system efficiently links feedback to the content by relying on the document vector, ensuring accurate and scalable content-feedback associations. This method allows the system to handle large volumes of data and feedback while maintaining precise connections between content and the corresponding user interactions.

At step 408, process 400 (e.g., using one or more components described above) generates the first response with the content. For example, the system may generate, by the first cloud-based collaboration and communication platform, the first secured response with the first content, wherein the first secured response and the first content comprise the encryption native to the first cloud-based collaboration and communication platform.

In some embodiments, the system generates a secured response on a cloud-based collaboration and communication platform by applying the platform's native encryption to both the content and the response, ensuring the security of the data during transmission and storage. When the platform processes a user request or query, such as a request for a document or a response to a question, it retrieves or generates the relevant content, which could be a file, a message, or another type of data. This content is then prepared for inclusion in the secured response. To safeguard the content, the system uses the native encryption protocols of the cloud-based platform. These encryption protocols are designed to ensure that any data processed or transmitted through the platform is securely encrypted to prevent unauthorized access. Once the content is identified, the system applies the platform's encryption to the first content, transforming it into an encrypted format that can only be decrypted by authorized users or systems with the correct keys.

Next, the system generates the first secured response by combining the encrypted content with any additional metadata or instructions needed for delivery. This response itself is also encrypted using the same native encryption protocols, ensuring that the entire message, along with the content, remains secure as it is transmitted through the cloud infrastructure. The encryption ensures that even if the data is intercepted during transmission, it cannot be accessed or understood without proper decryption credentials. The secured response is then sent to the intended recipient, where the system on the recipient's side, using the appropriate decryption keys and protocols, decrypts the response and presents the content securely. By applying encryption both to the content and the response, the platform ensures end-to-end security, protecting sensitive information from unauthorized access throughout the entire process. This process guarantees that the system can safely generate and transmit responses that contain sensitive or important information, providing a secure communication environment that aligns with the platform's security standards and encryption methods.

In some embodiments, the system generates the first secured response with the first content by inputting the first content into a first prompt generator and receiving the first secured response from the first prompt generator. The system generates a first secured response with the first content by utilizing a prompt generator to securely format and output the response. The process begins with the system identifying or retrieving the first content, which could be a document, message, or any other type of information requested by the user. Once the content is ready, it is input into the first prompt generator. The prompt generator is a component designed to take content and generate a structured response based on specific prompts or instructions. When the system inputs the first content into the prompt generator, the generator processes the content according to predefined rules or templates. These rules dictate how the content should be framed within the response, ensuring that it is formatted correctly and aligned with the user's request or the platform's requirements. The prompt generator also takes into account any security requirements, such as ensuring that sensitive data is handled appropriately. As part of this process, the prompt generator applies the platform's native encryption protocols to the content before generating the response. This encryption ensures that the response is secured and protected from unauthorized access. The prompt generator wraps the encrypted content in a structured response, which may include additional information such as metadata or instructions for delivery. The system then receives the first secured response from the prompt generator. This response contains the encrypted version of the first content, formatted and prepared for transmission. By using the prompt generator, the system ensures that the content is both properly structured and fully encrypted, maintaining security throughout the process. The secured response is then sent to the recipient, where it can be decrypted and accessed only by authorized users or systems. This method ensures that the system can generate secure responses efficiently, using the prompt generator to handle both the content formatting and encryption in a seamless process. It provides a secure and reliable way to transmit sensitive information while maintaining the integrity and confidentiality of the content.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for routing internal communications while maintaining a secured environment and security over internal data.

2. The method of the preceding embodiment, further comprising: receiving, at a first cloud-based collaboration and communication platform, a first secured input, wherein the first secured input comprises an encryption native to the first cloud-based collaboration and communication platform; processing, by the first cloud-based collaboration and communication platform, the first secured input using a large language model, wherein the large language model is trained using a first training routine, of a bifurcated security protocol, for weighting the large language model to determine routing instructions or data retrieval locations for content retrieval operations, and wherein the large language model is trained using a second training routine for weighting the large language model to determine intents or contexts of received inputs; determining, by the first cloud-based collaboration and communication platform, first content for appending to a first secured response to the first secured input based on (i) a first intent or context determined by the large language model and a first routing instruction or data retrieval location determined by the large language model; and (ii) filtering available content from a first dataset based on whether the available content has a first indicium of user feedback; and generating, by the first cloud-based collaboration and communication platform, the first secured response with the first content, wherein the first secured response and the first content comprise the encryption native to the first cloud-based collaboration and communication platform.

3. The method of any one of the preceding embodiments, further comprising: receiving the first dataset, wherein the first dataset comprises sensitive data, wherein the sensitive data is based on a first data source that is native to the first cloud-based collaboration and communication platform, and wherein the first dataset comprises the encryption native to the first cloud-based collaboration and communication platform; and receiving a second dataset comprising non-sensitive data, wherein the second dataset is based on a plurality of sources not native to the first cloud-based collaboration and communication platform, and wherein the second dataset does not comprise the encryption native to the first cloud-based collaboration and communication platform.

4. The method of any one of the preceding embodiments, further comprising: retrieving the bifurcated security protocol; and executing the bifurcated security protocol to perform the first training routine using the first dataset and to perform the second training routine using the second dataset.

5. The method of any one of the preceding embodiments, wherein executing the bifurcated security protocol to perform the first training routine further comprises: determining respective indicia of user feedback for content in the first dataset; and filtering the content in the first dataset based on the respective indicia of user feedback.

6. The method of any one of the preceding embodiments, wherein training the large language model using the second training routine further comprises: retrieving a first historic input corresponding to a first labeled intent or context; and training the large language model to classify the first historic input as the first labeled intent or context.

7. The method of any one of the preceding embodiments, wherein training the large language model using the first training routine further comprises: retrieving a first historic input corresponding to a first labeled content retrieval operation; and training the large language model to classify the first historic input as corresponding to the first labeled content retrieval operation.

8. The method of any one of the preceding embodiments, wherein training the large language model using the first training routine further comprises: retrieving a first historic content corresponding to a first labeled content retrieval operation; and training the large language model to classify the first historic content as corresponding to the first labeled content retrieval operation.

9. The method of any one of the preceding embodiments, wherein determining the first content further comprises: determining a number of the first indicium of user feedback that corresponds to the first content; retrieving a threshold number; and determining that the number of the first indicium of user feedback corresponds to the threshold number.

10. The method of any one of the preceding embodiments, wherein determining the first content further comprises: determining that the first indicium of user feedback corresponds to the first content; determining a quality ranking corresponding to the first indicium of user feedback; retrieving a threshold quality ranking; and determining that the quality ranking corresponding to the first indicium of user feedback corresponds to the threshold quality ranking.

11. The method of any one of the preceding embodiments, wherein determining the first content further comprises: determining that the first indicium of user feedback corresponds to the first content; determining a first user feedback type corresponding to the first indicium of user feedback; retrieving a required user feedback type; and determining that the first user feedback type corresponds to the required user feedback type.

12. The method of any one of the preceding embodiments, wherein determining the first content further comprises: determining that the first indicium of user feedback corresponds to the first content; determining an update frequency corresponding to the first indicium of user feedback; retrieving a threshold update frequency; and determining that the update frequency corresponding to the first indicium of user feedback corresponds to the threshold update frequency.

13. The method of any one of the preceding embodiments, wherein determining the first content further comprises: determining that the first indicium of user feedback corresponds to the first content; determining a receipt date corresponding to the first indicium of user feedback; retrieving a threshold receipt date for user feedback; and determining that the receipt date corresponds to the threshold receipt date.

14. The method of any one of the preceding embodiments, wherein determining the first content further comprises: determining a document vector corresponding to the first content; and determining that the first indicium of user feedback corresponds to the first content based on the document vector.

15. The method of any one of the preceding embodiments, wherein determining the routing instructions or the data retrieval locations for the content retrieval operations further comprises: determining a content type corresponding to a content retrieval operation; and determining a network pathway to a data source corresponding to the content type.

16. The method of any one of the preceding embodiments, wherein processing the first secured input using the large language model further comprises: determining a feature input corresponding to the first secured input; and inputting the feature input into the large language model.

17. The method of any one of the preceding embodiments, wherein generating the first secured response with the first content further comprises: inputting the first content into a first prompt generator; and receiving the first secured response from the first prompt generator.

18. One or more non-transitory, computer-readable mediums storing instructions that, when executed by a data processing apparatus, cause the data processing apparatus to perform operations comprising those of any of embodiments 1-17.

19. A system comprising one or more processors; and memory storing instructions that, when executed by the processors, cause the processors to effectuate operations comprising those of any of embodiments 1-17.

20. A system comprising means for performing any of embodiments 1-17.

What is claimed is:

1. A system for routing internal communications while maintaining a secured environment and security over internal data using bifurcated security protocols, the system comprising:
one or more processors; and
one or more non-transitory, computer readable media comprising instructions that when executed by the one or more processors cause operations comprising:
receiving a first dataset comprising sensitive data, wherein the sensitive data is based on a first data source that is native to a first cloud-based collaboration and communication platform, and wherein the first dataset comprises an encryption native to the first cloud-based collaboration and communication platform;
receiving a second dataset comprising non-sensitive data, wherein the second dataset is based on a plurality of sources not native to the first cloud-based collaboration and communication platform, and wherein the second dataset does not comprise the encryption native to the first cloud-based collaboration and communication platform;
retrieving a bifurcated security protocol, wherein the bifurcated security protocol comprises a first training routine for weighting a large language model to determine routing instructions or data retrieval locations for content retrieval operations, and wherein the bifurcated security protocol comprises a second training routine for weighting the large language model to determine an intent or context of received inputs;
executing the bifurcated security protocol to perform the first training routine using the first dataset and to perform the second training routine using the second dataset;
in response to executing the bifurcated security protocol, retrieving the large language model;
receiving, at the first cloud-based collaboration and communication platform, secured inputs, wherein the secured inputs comprise the encryption native to the first cloud-based collaboration and communication platform; and
generating, by the first cloud-based collaboration and communication platform, respective responses to the secured inputs using the large language model, wherein the respective responses the encryption native to the first cloud-based collaboration and communication platform.

2. A method for routing internal communications while maintaining a secured environment and security over internal data, the method comprising:
receiving, at a first cloud-based collaboration and communication platform, a first secured input, wherein the first secured input comprises an encryption native to the first cloud-based collaboration and communication platform;
processing, by the first cloud-based collaboration and communication platform, the first secured input using a large language model, wherein the large language model is trained using a first training routine, of a bifurcated security protocol, for weighting the large language model to determine routing instructions or data retrieval locations for content retrieval operations, and wherein the large language model is trained using a second training routine for weighting the large language model to determine intents or contexts of received inputs;
determining, by the first cloud-based collaboration and communication platform, first content for appending to a first secured response to the first secured input based on (i) a first intent or context determined by the large language model and a first routing instruction or data retrieval location determined by the large language model; and (ii) filtering available content from a first dataset based on whether the available content has a first indicium of user feedback; and
generating, by the first cloud-based collaboration and communication platform, the first secured response with the first content, wherein the first secured response and the first content comprise the encryption native to the first cloud-based collaboration and communication platform.

3. The method of claim 2, further comprising:
receiving the first dataset, wherein the first dataset comprises sensitive data, wherein the sensitive data is based on a first data source that is native to the first cloud-based collaboration and communication platform, and wherein the first dataset comprises the encryption native to the first cloud-based collaboration and communication platform; and
receiving a second dataset comprising non-sensitive data, wherein the second dataset is based on a plurality of sources not native to the first cloud-based collaboration and communication platform, and wherein the second dataset does not comprise the encryption native to the first cloud-based collaboration and communication platform.

4. The method of claim 3, further comprising:
retrieving the bifurcated security protocol; and
executing the bifurcated security protocol to perform the first training routine using the first dataset and to perform the second training routine using the second dataset.

5. The method of claim 4, wherein executing the bifurcated security protocol to perform the first training routine further comprises:
determining respective indicia of user feedback for content in the first dataset; and
filtering the content in the first dataset based on the respective indicia of user feedback.

6. The method of claim 2, wherein training the large language model using the second training routine further comprises:
retrieving a first historic input corresponding to a first labeled intent or context; and
training the large language model to classify the first historic input as the first labeled intent or context.

7. The method of claim 2, wherein training the large language model using the first training routine further comprises:
retrieving a first historic input corresponding to a first labeled content retrieval operation; and
training the large language model to classify the first historic input as corresponding to the first labeled content retrieval operation.

8. The method of claim 2, wherein training the large language model using the first training routine further comprises:
retrieving a first historic content corresponding to a first labeled content retrieval operation; and
training the large language model to classify the first historic content as corresponding to the first labeled content retrieval operation.

9. The method of claim 2, wherein determining the first content further comprises:
determining a number of the first indicium of user feedback that corresponds to the first content;
retrieving a threshold number; and
determining that the number of the first indicium of user feedback corresponds to the threshold number.

10. The method of claim 2, wherein determining the first content further comprises:
determining that the first indicium of user feedback corresponds to the first content;
determining a quality ranking corresponding to the first indicium of user feedback;
retrieving a threshold quality ranking; and
determining that the quality ranking corresponding to the first indicium of user feedback corresponds to the threshold quality ranking.

11. The method of claim 2, wherein determining the first content further comprises:
determining that the first indicium of user feedback corresponds to the first content;
determining a first user feedback type corresponding to the first indicium of user feedback;
retrieving a required user feedback type; and
determining that the first user feedback type corresponds to the required user feedback type.

12. The method of claim 2, wherein determining the first content further comprises:
determining that the first indicium of user feedback corresponds to the first content;
determining an update frequency corresponding to the first indicium of user feedback;
retrieving a threshold update frequency; and
determining that the update frequency corresponding to the first indicium of user feedback corresponds to the threshold update frequency.

13. The method of claim 2, wherein determining the first content further comprises:
determining that the first indicium of user feedback corresponds to the first content;
determining a receipt date corresponding to the first indicium of user feedback;
retrieving a threshold receipt date for user feedback; and
determining that the receipt date corresponds to the threshold receipt date.

14. The method of claim 2, wherein determining the first content further comprises:
determining a document vector corresponding to the first content; and
determining that the first indicium of user feedback corresponds to the first content based on the document vector.

15. The method of claim 2, wherein determining the routing instructions or the data retrieval locations for the content retrieval operations further comprises:
determining a content type corresponding to a content retrieval operation; and
determining a network pathway to a data source corresponding to the content type.

16. The method of claim 2, wherein processing the first secured input using the large language model further comprises:
determining a feature input corresponding to the first secured input; and
inputting the feature input into the large language model.

17. The method of claim 2, wherein generating the first secured response with the first content further comprises:
inputting the first content into a first prompt generator; and
receiving the first secured response from the first prompt generator.

18. One or more non-transitory, computer-readable media, comprising instructions that, when executed by one or more processors, cause operations comprising:
receiving, at a first cloud-based collaboration and communication platform, a first input;
processing, by the first cloud-based collaboration and communication platform, the first input using a large language model, wherein the large language model is trained using a first training routine, of a bifurcated security protocol, for weighting the large language model to determine routing instructions or data retrieval locations for content retrieval operations, and wherein the large language model is trained using a second training routine for weighting the large language model to determine intents or contexts of received inputs;
determining, by the first cloud-based collaboration and communication platform, first content for appending to a first response to the first input based on (i) a first intent or context determined by the large language model and a first routing instruction or data retrieval location determined by the large language model; and (ii) filtering available content from a first dataset based on whether the available content has a first indicium of user feedback; and
generating, by the first cloud-based collaboration and communication platform, the first response with the first content.

19. The one or more non-transitory, computer-readable media of claim 18, wherein determining the first content further comprises:
determining a document vector corresponding to the first content; and
determining that the first indicium of user feedback corresponds to the first content based on the document vector.

20. The one or more non-transitory, computer-readable media of claim 18, wherein determining the routing instructions or the data retrieval locations for the content retrieval operations further comprises:
determining a content type corresponding to a content retrieval operation; and
determining a network pathway to a data source corresponding to the content type.
